(19) United States
(12) Patent Application Publication
(10) Pub. No.: US 2019/0298499 A1
(43) Pub. Date: Oct. 3, 2019

(54) THERMOPLASTIC FILM KIT

(71) Applicants: Kimberly Fregoso, Sun Valley, CA (US); Jose Fregoso, Sun Valley, CA (US)

(72) Inventors: Kimberly Fregoso, Sun Valley, CA (US); Jose Fregoso, Sun Valley, CA (US)

(21) Appl. No.: 15/936,623

(22) Filed: Mar. 27, 2018

(51) Int. Cl. A61C 13/00; A61C 13/08

(52) U.S. Cl. CPC A61C 13/0022; A61C 13/081; B29C 51/002; A61C 2201/002; A61C 13/082

(57) ABSTRACT

A thermoplastic film kit for cosmetic dental repairs includes a plurality of sheets. Each sheet has a respective color so that the plurality of sheets comprises a plurality of colors. The sheets comprise thermoplastic and are configured to be thermoformed. A respective sheet that has an associated color, which substantially matches teeth that are positioned adjacent to a portion of a bite of a patient, is configured to be thermoformed to a cast that is prepared from a mold of the portion of the bite. The thermoforming of the respective sheet generates a covering that is configured to be bonded to the teeth within the portion of the bite to cover abnormal teeth. The associated color of the covering matches the teeth that are positioned adjacent to the portion of the bite.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

### (2) Description of Related Art including information disclosed under 37 CFR 1.97 and 1.98.

The disclosure and prior art relates to film kits and more particularly pertains to a new film kit for cosmetic dental repairs.

### BRIEF SUMMARY OF THE INVENTION

An embodiment of the disclosure meets the needs presented above by generally comprising a plurality of sheets. Each sheet has a respective color so that the plurality of sheets comprises a plurality of colors. The sheets comprise thermoplastic and are configured to be thermoformed. A respective sheet that has an associated color, which substantially matches teeth that are positioned adjacent to a portion of a bite of a patient, is configured to be thermoformed to a cast that is prepared from a mold of the portion of the bite. The thermoforming of the respective sheet generates a covering that is configured to be bonded to the teeth within the portion of the bite to cover abnormal teeth. The associated color of the covering matches the teeth that are positioned adjacent to the portion of the bite.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a isometric perspective view of a thermoplastic film kit according to an embodiment of the disclosure.

FIG. 2 is a bottom view of an embodiment of the disclosure.

FIG. 3 is a side view of an embodiment of the disclosure.

FIG. 4 is a back view of an embodiment of the disclosure.

FIG. 5 is an in-use view of an embodiment of the disclosure.

FIG. 6 is a detail view of an embodiment of the disclosure.

### DETAILED DESCRIPTION OF THE INVENTION

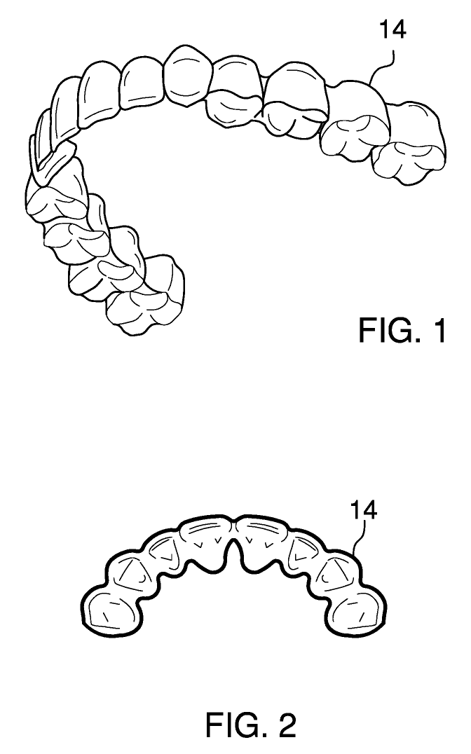

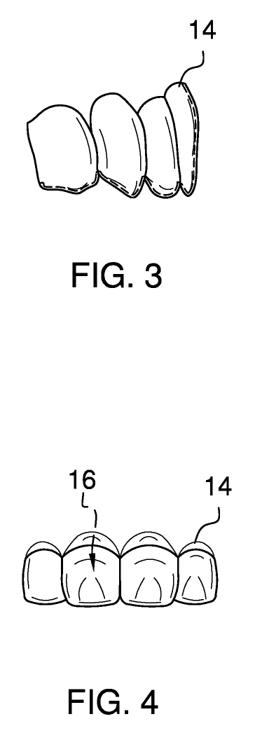

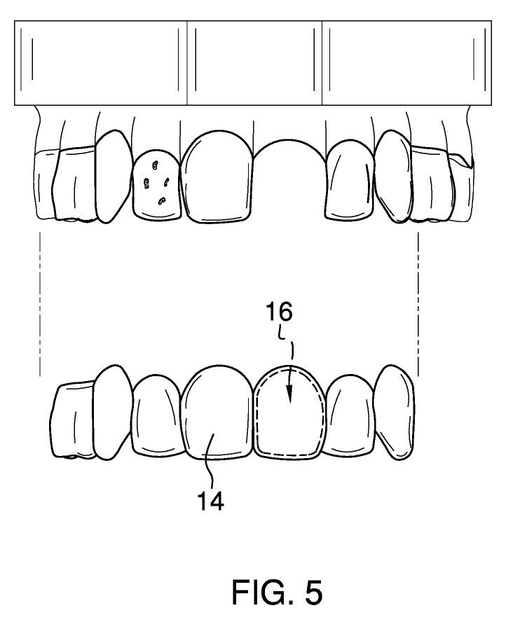

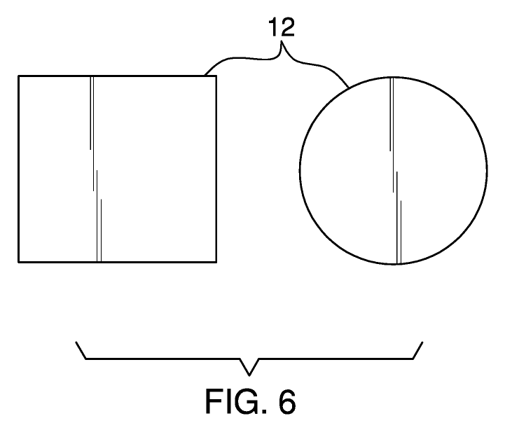

With reference now to the drawings, and in particular to FIGS. 1 through 6 thereof, a new film kit embodying the principles and concepts of an embodiment of the disclosure and generally designated by the reference numeral 10 will be described.

As best illustrated in FIGS. 1 through 6, the thermoplastic film kit 10 generally comprises a plurality of sheets 12. Each sheet 12 has a respective color so that the plurality of sheets 12 comprises a plurality of colors. The sheets 12 comprise thermoplastic and are configured to be thermoformed using methods well known to those skilled in the art. A respective sheet 12 that has an associated color, which substantially matches teeth that are positioned adjacent to a portion of a bite of a patient, is configured to be thermoformed to a cast that is prepared from a mold of the portion of the bite. The thermoforming of the respective sheet 12 generates a covering 14 that is configured to be bonded to the teeth within the portion of the bite to cover abnormal teeth, such as a tooth that is stained or otherwise discolored. The associated color of the covering 14 matches the teeth that are positioned adjacent to the portion of the bite.

Each sheet 12 is rectangularly shaped, squarely shaped, circularly shaped, or the like. The covering 14 may be vacuum-formed or pressure-formed.

The kit 10 also comprises a pontic 16 that has a shape similar to a missing tooth in the portion of the bite of the patient. The pontic 16 is releasably coupled to the cast. The pontic 16 is decoupled from the cast and is coupled to the covering 14 as the sheet 12 is thermoformed to the cast. The pontic 16 is configured to fill a gap from the missing tooth when the covering 14 is bonded to the teeth within the portion of the bite, effectively bridging the gap. The associated color of the covering 14 matches the teeth that are positioned adjacent to the portion of the bite.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A thermoplastic film kit comprising:
a plurality of sheets, each said sheet having a respective color such that said plurality of sheets comprises a plurality of colors, said sheets comprising thermoplastic wherein a respective said sheet having an associated color substantially matching teeth positioned adjacent to a portion of a bite of a patient is configured for thermoforming to a cast prepared from a mold of the portion of the bite for generating a covering configured for bonding to the teeth within the portion of the bite for covering abnormal teeth such that the associated color of the covering matches the teeth positioned adjacent to the portion of the bite; and
a pontic shaped similarly to a missing tooth in the portion of the bite of the patient, said pontic being releasably coupled to the cast such that said pontic is decoupled from the cast and coupled to said covering as said sheet is thermoformed to the cast wherein said pontic is configured for filling a gap from the missing tooth when said covering is bonded to the teeth within the portion of the bite and wherein the associated color of the covering matches the teeth positioned adjacent to the portion of the bite.

2. The kit of claim 1, further including each said sheet being rectangularly shaped.

3. The kit of claim 2, further including each said sheet being squarely shaped.

4. The kit of claim 1, further including each said sheet being circularly shaped.

5. (canceled)

6. A thermoplastic film kit comprising:
a plurality of sheets, each said sheet having a respective color such that said plurality of sheets comprises a plurality of colors, said sheets comprising thermoplastic wherein a respective said sheet having an associated color substantially matching teeth positioned adjacent to a portion of a bite of a patient is configured for thermoforming to a cast prepared from a mold of the portion of the bite for generating a covering configured for bonding to the teeth within the portion of the bite for covering abnormal teeth such that the associated color of the covering matches the teeth positioned adjacent to the portion of the bite, each said sheet being rectangularly shaped, each said sheet being squarely shaped, each said sheet being circularly shaped; and
a pontic shaped similarly to a missing tooth in the portion of the bite of the patient, said pontic being releasably coupled to the cast such that said pontic is decoupled from the cast and coupled to said covering as said sheet is thermoformed to the cast wherein said pontic is configured for filling a gap from the missing tooth when said covering is bonded to the teeth within the portion of the bite and wherein the associated color of the covering matches the teeth positioned adjacent to the portion of the bite.
